(19) United States
(12) Patent Application Publication
(10) Pub. No.: US 2011/0252951 A1
(43) Pub. Date: Oct. 20, 2011

(54) REAL TIME CONTROL OF MIDI PARAMETERS FOR LIVE PERFORMANCE OF MIDI SEQUENCES

(75) Inventors: Michael G. Leavitt, Provo, UT (US); David A. Zabriskie, Sandy, UT (US)

(73) Assignee: LEAVITT AND ZABRISKIE LLC, Sandy, UT (US)

(21) Appl. No.: 13/085,997

(22) Filed: Apr. 13, 2011

Related U.S. Application Data
(60) Provisional application No. 61/325,891, filed on Apr. 20, 2010.

(51) Int. Cl. G10H 7/00

(52) U.S. Cl. 84/645

(57) ABSTRACT

A computer-implemented method for real time control of a MIDI beat clock includes moving a hand-held device to create movement signals, transmitting the movement signals to a computer device, analyzing the movement signals with a computer device, and controlling a MIDI beat clock according to the analyzed movement signals.

### RELATED APPLICATIONS

This application claims priority to U.S. Application No. 61/325,891, entitled REAL TIME CONTROL OF MIDI BEAT CLOCK FOR LIVE PERFORMANCE OF MIDI SEQUENCES NOT BOUND TO STRICT MATHEMATICAL TIMES, and filed on Apr. 20, 2010, which is incorporated herein in its entirety by this reference.

### BACKGROUND

Musical instrument digital interface (MIDI) is a communication standard that allows musical instruments and computers to talk to each other using a common language. MIDI is a standard, a protocol, a language, and a list of specifications. It identifies not only how information is transmitted, but also what transmits this information. MIDI is a music description language in binary form in which each binary word describes an event in a musical performance.

MIDI is a common language that is shared between compatible devices and software that allows musicians, sound and light engineers, and others who use computers and electronic musical instruments to create, listen to, and learn about music, a way to electronically communicate. MIDI may be particularly applicable to keyboard instruments in which the events are associated with the keyboard and the action of pressing a key to create a note is like activating a switch ON, and the release of that key/note is like turning the switch OFF. Other musical applications and/or musical instruments may be used with MIDI. MIDI controls software instruments and samplers focusing on realistic instrument sounds to create a live orchestra feel with the help of sophisticated sequencers.

However, MIDI is generally mechanically based such that MIDI controls the beats per measure (BPM) with a mechanical feel. The precision and mechanical basis to MIDI results in a MIDI beat that follows strict mathematical pulses. The music generated by following a MIDI beat typically lacks a human feel (emotion and less than perfect tempo) and is unable to be adapted in real time during a performance. Thus, against this background it would be desirous to provide systems and methods that address the above and other issues associated with MIDI.

### SUMMARY

In one example, a computer-implemented method for real time control of a MIDI Beat Clock includes moving a hand-held device to create movement signals, transmitting the movement signals to a computer device, analyzing the movement signals with a computer device, and controlling a MIDI Beat Clock according to the analyzed movement signals.

Another example relates to a computer system configured to provide real time adjustment to music parameters during the generation of a digital music output. The computer system includes a processor, memory in electronic communication with the processor, and a timing module. The timing module is configured to receive a movement signal from a movement device being moved by a user, analyze the movement signals, adjust a music parameter in accordance with the movement signals, and output the adjusting music parameter to influence the generation of the digital music output.

Another example relates to a computer-program product for adjusting a tempo of a prerecorded digital music file. The computer program product includes a computer-readable medium having instructions thereon. The instructions include code programmed to receive movement signals from a hand-held device being moved, code programmed to analyze the movement signals, code programmed to adjust a tempo of a prerecorded digital music file in accordance with the movement signals, and code programmed to output the prerecorded digital music file having an adjusted tempo.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram illustrating one embodiment of a system for real time control of MIDI parameters to implement the present systems and methods.

FIG. 2 is a block diagram illustrating aspects of the hand-held device of the system of FIG. 1.

FIG. 3 is a block diagram illustrating aspects of the computing device of the system of FIG. 1.

FIG. 4 is a block diagram illustrating aspects of an analyzing module of the computing system of FIG. 3.

FIG. 5 is a block diagram illustrating aspects of the system of FIG. 1.

FIG. 6 is a flow diagram illustrating one embodiment of a method for controlling a MIDI Beat Clock according to movement signals.

FIG. 7 is a flow diagram illustrating one embodiment of a method for adjusting a music parameter in accordance with movement signals.

FIG. 8 is a flow diagram illustrating one embodiment of a method of adjusting a tempo of a prerecorded digital music file in accordance with movement signals.

FIG. 9 is a diagram showing test data related to the present systems and methods.

FIG. 10 depicts a block diagram of a computer system suitable for implementing the present systems and methods.

FIG. 11 is a block diagram depicting a network architecture in which client systems as well as storage servers are coupled to a network.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The present disclosure is directed to systems and methods that facilitate the humanized control of a MIDI sequence using an algorithm and software to control, in real time, such parameters as the tempo markings (BPM), ritardandos (slowing down), accelerandos (speeding up), fermatas (holds), crescendos (getting louder), decrescendos (getting softer), and the overall balance of instrument sounds for a sequenced orchestra (either a virtual sequenced orchestra and/or a digital sequenced orchestra).

One aspect of the present disclosure relates to a software program that permits a conductor (using a hand-held device such as a Wii® controller, available from Nintendo at America, Inc., for example) to control the tempo of music that a computerized system (e.g., a digital music file) supplies. The conductor may control the tempo using conventional hand movements associated with moving a conducting baton. This permits musicians playing along with the computerized music (or a computer-generated beat) to be in sync with the beat set by the conductor (e.g., the movement of the conductor's hands) rather than being controlled mechanically by a pre-set computerized beat. The use of a pre-set beat does not allow for humanization of the music in accordance with, for example, the conductor's emotions, his or her interpretation of the musical score, or the performance of, for example, a singer that the conductor is following. By giving the conductor the freedom to change the musical tempo and other aspects of the music, the conductor can make the music and the beat more dynamic and adaptable to the particular score, setting, performance, etc.

Another aspect of the present disclosure relates to a computer system having a software program that will receive signals from the conductor that is using a hand-held device (e.g., the Wii® controller). The hand-held device senses movement of the conductor's hands and sends signals that are received by the computer system. The computer system analyzes these movements to determine the beat based upon the movement signals generated by the hand-held controller. As the conductor manipulates the movement and/or of the hand-held controller, the beat will be similarly affected. The software program then adjusts the beat of the music accordingly. This beat will be output to the orchestra or other music generating devices. In one example, a prerecorded digital music file will have its beat adjusted in accordance with the output beat. Likewise, any accompanying live musicians will also receive the adjusted beat and can similarly adjust their playing. Consequently, the conductor is able to maintain control of the tempo of the music.

The generation of music using MIDI includes MIDI Time Code and MIDI Beat Clock. These aspects are described as follows.

### MIDI Time Code

MIDI Time Code (MTC) embeds the same timing information as defined by the Society of Motion Picture and Television Engineers (SMPTE) standards time code, which may change from time to time, as a series of small “quarter-frame” MIDI messages. There is no provision for the user bits in the standard MIDI Time Code messages, so the system exclusive (SYSEX) messages are used to carry this information instead. The quarter frame messages are transmitted in a sequence of eight messages so that a complete time code value is specified every two frames. If the MIDI data stream, which is transmitted and received on a serial port, is running close to capacity, the MTC data may arrive a little behind schedule, which has the effect of introducing a small amount of jitter. In order to avoid this, it may be desirable to use a completely separate MIDI port for MTC data. Larger full-frame messages, which encapsulate a frame worth of time code in a single message, are used to locate to a time while time code is not running.

Unlike the time SMPTE time code, MIDI time codes quarter-frame and full-frame messages carry a two-bit flag value that identifies the rate of the time code, specifically as either:
24 frames/sec (standard rate for film work)
25 frames/sec (standard rate for PAL video)
30 frames/sec (drop-frame time code for MTSC video)
30 frames/sec (non-drop time code for MTSC video)

MTC distinguishes between film speed and video speed only by the rate at which time code advances, but not by the information contained in the time code messages. Thus, for example, 29.97 frames/sec drop frame is represented as 30 frames/sec drop frame at 0.1 percent pull down.

MTC allows the synchronization of a sequencer or DAW with other devices that can synchronize to MTC, or for these devices to “slave” to a tape machine that is striped with SMPTE. An SMPTE to MTC converter is typically used to conduct this step. It may be possible for a tape machine to synchronize to a MTC signal (if converted to SMPTE) if the tape machine is able to “slave” to an incoming time code via a motor control in rare cases.

### MIDI Beat Clock

MIDI beat clock is a clock signal that is broadcast via MIDI to ensure that several synthesizers stay in synchronization. MIDI beat clock is distinct from MIDI time code. Unlike MIDI time code, MIDI beat clock is sent at a rate that represents the current tempo (e.g., 24 PPQN (pulses per quarter note)). MIDI beat clock may be used to maintain a synchronized tempo for synthesizers that have BPM-dependent voices and also for arpeggiator synchronization. MIDI beat clock does not transmit location information (e.g. bar number or time code) and thus must be used in conjunction with a positional reference such as time code for complete synchronization.

The limitations in MIDI and synthesizers sometimes impose clock drift in devices driven by MIDI beat clock. It is a common practice on equipment that supports another clock source such as ADAT or word clock to use both that source and MIDI beat clock.

MIDI is not recorded audio, but rather is a sequence of timed events (data bytes) such as note ON and note OFF. Conventionally, the timing clock in MIDI does not allow tempo changes within a measure unless physically hard-coded into the sequence. Thus, the MIDI time clock within a measure does not allow for the humanization of the note. Consequently, music generated by MIDI typically, depending on the experience of the user, sounds very mechanical and rigid.

Since the beginning of MIDI, MIDI keyboards or any outside MIDI source have been able to control the MIDI beat clock to change the tempo during the performance. The tempo change, however, is abrupt and controlled only through human tapping on the keyboard or through input via another MIDI device. This method of tapping is widely used, but does not take into account the human feel of added flow within the beat. Ritardandos and accelerandos (i.e., changes in the tempo of the music) can be hard coded into the sequence to give a more human feel. However, these changes in tempo are hard coded into the digital music file and not created in real time. Still further, a manual input such as human tapping on the keyboard, requires another person in addition to the conductor to make modifications to the music. In many cases, the number of persons available is limited, and the addition of further persons in the making of music can add significant cost.

One aspect of the present disclosure relates to controlling the MIDI beat clock (MBC) in real time. This real time control of the MIDI beat clock helps provide a human feel in the music that is generated. This human feel is controlled by a human—specifically the conductor of the music. The conductor has real time control of the music parameters as discussed above.

The conductor's main tool in directing/communicating musical tempo and nuances to the live musicians being directed by the conductor is a baton or bare hand. As noted above, the conductor may be supplied with a hand-held device to simulate a baton, such as a Nintendo® Wii® controller, to track the movements of the conductor's hand. While a Wii® controller is an exemplary device, other devices to track motion may be used. The Wii® control, or any handheld controller, may be in electronic communication with a computer system via, for example, BLUETOOTH or other wireless technology. In one example, a software program such as, for example, MAC OSculator, which allows the Wii® controller to communicate with MIDI. The BLUETOOTH messages from the Wii® controller are translated into recognizable MIDI messages. Using a virtual MIDI port, the OSculator MIDI message is connected to a MOTU digital performer (DP) that houses a full MIDI sequence. Within DP, the MIDI beat clock is set to be controlled by the OSculator MIDI message using DP's Tap Tempo MIDI Synchronization controller. Once the DP MIDI synchronization controller is started, the MIDI Beat Clock from OSculator plays the existing sequence within DP. DP then sends the MIDI sequence information to a software program such as, for example, Apple's Logic Pro software, which converts the incoming signal into virtual instrument information to be used as the audio sampling player. Through these and other sequences, the MIDI Beat Clock is controlled. As discussed above, the exactness of MIDI results in the beat sounding mechanical rather than having a human feel.

The MIDI beat can be controlled by most MIDI external sources such as a synthesizer keyboard, MIDI drums, or a computer keyboard. If the conductor chooses to use current technology to play sequenced MIDI tracks to his own beat, the conductor follows something similar to the following chain of events:
the conductor conducts the beat;
the keyboardist controlling the MIDI beat clock interprets the conductor's beat and strikes a note on the keyboard on every beat in order for the sequence of music to play;
the choir or musicians respond to the beat and tempo made by the keyboardist.

In reality, the keyboardist controlling the beat is the individual that actually controls the tempo of the music by interpreting the conductor's movements and gestures. Providing a handheld controller in the hand of a conductor eliminates the need for the keyboardist to interpret the conductor's movements and control the tempo. The conductor, thus, has complete control over the sequence including, for example, the tempo, dynamics, fermatas, and other musical nuances (i.e., music parameters). Although the handheld controller eliminates an extra step and additional interpretation in making modifications to the musical nuances, the mechanical feel of MIDI has not been completely resolved. Another aspect of the present disclosure relates to a process not only of incrementing or decrementing a tempo, but providing each beat with its own tempo or duration characteristic.

In order to “humanize” the beat and give the conductor complete human control of the beat in musical expression, an algorithm may be used. An example algorithm is based on results from a series of tests conducted to better understand how the human mind and body respond to a set beat. The tempos (BPM) used in the testing were set at 60, 80, 100, 120, 140, 160, 180 and 200. The conductor would then click a switch on the Wii™ controller every time a “click” sound would play at the given tempo. Sixteen beeps per tempo were used. Although the BPM played was mathematically the same for every beat, the human response was rarely exact. The human response was typically early or late relative to the mechanical beat, although in a few instances the human response landed directly on the beat. Musical nuance is typically defined as the ebb and flow of timing from beat to beat. One result of the testing showed that musical nuance is automatically generated when a human is involved in creating the beat.

The testing also included measuring the response time when the Wii® controller switch goes from the first instance of the ON state to its OFF state. Measurements confirm that the slower the tempo (BPM), the longer the ON state of the switch, and the faster the tempo, the shorter the ON state of the switch.

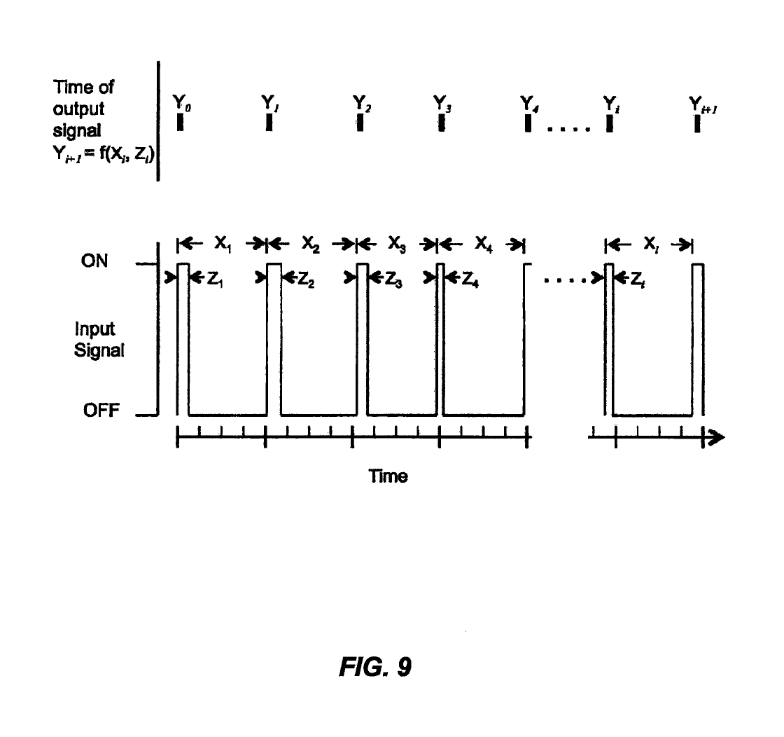

The diagram shown in FIG. 9 helps explains some of the test data. This data was used to create a humanized beat algorithm that provides real time adjustment of parameters such as accelerandos, ritardandos, fermatas, beat change, tempo change, and complete stop within a specified measure. This diagram illustrates how the conductor provides an input beat by clicking the Wii® controller at a timed interval denoted by X. The system also measures the length of time that the switch is in the ON state, which is denoted by Z. The output musical beat is represented as a discreet output signal Y, which is controlling the rate at which the music is played. The time at which the next beat will occur is sensed by the system through the input signals provided by the conductor, and predicted by the algorithm, allowing the algorithm to respond in a way that mimics a real person. Between the beats, the rate at which the musical notes are played is smoothly adjusted so that all the notes are played between Yᵢ and Yᵢ₊₁. The time at which the next beat will happen (Yᵢ₊₁) is computed as a special function of the current and past values of both Xᵢ and Zᵢ.

The relationship between X, Y and Z is based on a weighted filter of N previous values of the measured X, as well as an empirically-based functional dependence on Zᵢ, which may act as multiplicative (denoted g₁(Zᵢ, Zᵢ₋₁ . . . )) or additive (denoted g₂(Zᵢ, Zᵢ₋₁ . . . )) functions. This specific form is not hardwired, but is adjustable and may include approximate derivative information. However, in generic form, this relationship may be expressed in Equation 1 as follows:

$${Y}_{i + 1} = f ( {x}_{i} , {X}_{i - 1} , … , {Z}_{i} , {Z}_{i - 1} , … ) = {g}_{1} ( {Z}_{i} , {Z}_{i - 1} , … ) ⌊ {w}_{N} {X}_{i} + {w}_{N - 1} {X}_{i - 1} + … {w}_{1} {X}_{i - N + 1} ⌋ + {g}_{2} ( {Z}_{i} , {Z}_{i - 1} , … ) \\ Where \text{:} \\ N is the number of past values of X upon which to base the filter . \\ {\sum }_{j = 1}^{N} {w}_{j} = 1 is the physical constraint that requires the filter weights to sum to 1. \\ {g}_{1} ( {Z}_{1} , {Z}_{i - 1} , … ) is a function of current and past {Z}_{i} that acts as a multiplier . \\ {g}_{2} ( {Z}_{1} , {Z}_{i - 1} , … ) is a function of current and past {Z}_{i} that acts as an additive term . \qquad Equation 1$$

The empirically-based functions g₁ (Zᵢ, Zᵢ₋₁, . . . ) and g₂ (Zᵢ, Zᵢ₋₁, . . . ) are based on measured data reflecting natural human trends to vary the value of Z as the tempo changes. This process allows the output tempo to be controlled by a conductor in a customizable and musically satisfying way. The customization comes by adjusting or modifying N, wⱼ, g₁, and g₂.

This algorithm, which may be referred to as the MIDI conductor algorithm, may have particular relevance in musical theatre, for example. When a live orchestra is not available, many musical theatre production groups have a sequenced track of music made and recorded for playback during the performance. All of the live singers and instrumentalists (if any) will perform to the recorded track. The performance of the track is left to the sequencer. The playback performances are always the same and allow very little expression for the singer from beat to beat. The MIDI conductor algorithm allows full musical expression to the singer on stage by giving the singer the freedom to express the music in their own way as the conductor, holding the Wii™ controller (or other hand-held control device), tracks the singer's performance thereby altering a parameter or nuance of the music.

The present system and related methods are not intended to eliminate the musician, but rather give more opportunities for live musical performance that has a human feel. The present system and methods are designed so that a musical production (e.g., a musical theatre production) can have a live, full orchestra sound as a stand alone or with the addition of live players. The system may provide a “click track” in order for live musicians to more easily play along with the sequenced tracks.

Another aspect of the present disclosure relates to an educational tool wherein the system facilitates teaching of conductors to conduct an orchestra with human response. The system may be used for students who are professional performers to practice rehearsing with a sequenced orchestra in real time and allowing the soloist to express his or her own feeling to the music with a live conductor. Another example application relates to film scoring, wherein the system and methods provide the composer with an opportunity to conduct to film with a human feel of his or her sequenced track, with the option of adding live players if desired. Conducting live provides an emotional feel that cannot typically be achieved by a mechanical, prerecorded sequence.

Other applications for the MIDI conductor sequence and related systems and methods disclosed herein include: live concerts, incidental music for dramatic productions, recording technologies, synchronized lighting and pyrotechnics production, multi-media variety show, creating humanized click track, educational products for students, professionals and amateurs, educational training for conductors and performers, dance productions, touring performance groups, and DJs.

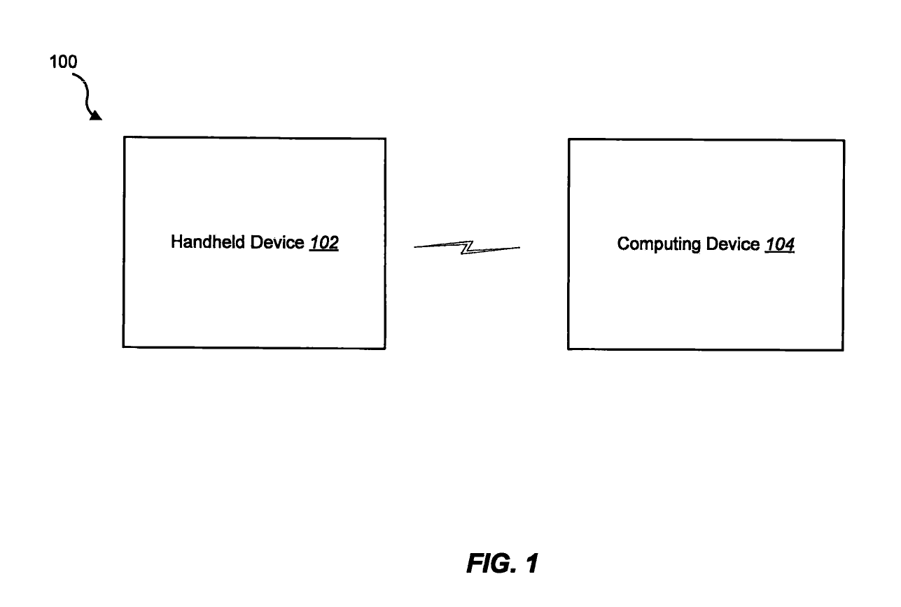

Referring now to FIG. 1, a block diagram is shown illustrating one embodiment of a system 100 that includes a hand-held device 102 and a computing device 104. The hand-held device 102 may communicate with a computing device 104 wirelessly. In other arrangements, the hand-held device 102 may have a wired connection to the computing device 104. Many different types of wireless communications are possible to provide electronic communication between the hand-held device 102 and computing device 104, such as, for example, BLUETOOTH and Home RF to name but two protocols.

Typically, the hand-held device 102 is configured to detect movement of a user that carries the hand-held device 102. In one example, the hand-held device is carried in a hand of a user (e.g., a music conductor). As the music conductor moves his hand to direct music being played by musicians, a song being sung by singers, etc., the hand-held device senses the movement and creates a movement signal.

The movement signal is communicated to the computing device 104. In some arrangements, the hand-held device is not literally carried by a hand of the user. For example, the hand-held device 102 may be secured to a different portion of the user such as, for example, along a back side of the hand, along a portion of the forearm, or a finger of the user. The hand-held device 102 may include a plurality of portions that are carried or mounted to different portions of a user such as, for example, on separate hands, separate fingers of a given hand, or at different locations along the hand and forearm of a user. The hand-held device 102 may be connected to other body parts in place of or in combination to mounting to the hand or arm of the user. For example, the hand-held device 102 may be connected to the head, foot or leg of the user.

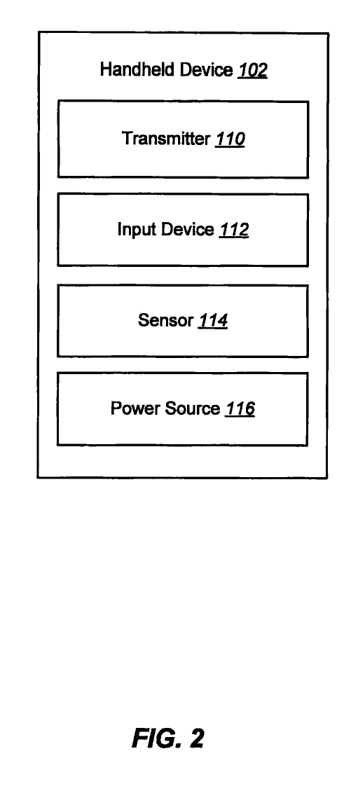

Referring to FIG. 2, the hand-held device 102 may include a plurality of components such as, for example, a transmitter 110, an input device 112, a sensor 114, and a power source 116. The hand-held device may include, in some examples, fewer components, additional components, or additional numbers of any one of the components shown in FIG. 2. In one example, the transmitter 110 is configured to transmit an electronic signal in the form of, for example, a movement signal to the computing device 104. The transmitter 110 may utilize any desired wireless communication protocol such as, for example, blue tooth technology.

The input device 112 may include at least one physical input device such as, for example, a button, a switch, a touch input surface, or a voice activated device. The hand-held device 102 may include a plurality of input devices, wherein each input device 112 provides a separate function. In one example, the input device 112 may be used to increase or decrease by increments (e.g., by increments of 1) the BPM each time the input device 112 is operated.

The sensor 114 may include at least one motion sensor. Other example sensors include, for example, accelerators, gyroscopes, force sensors, or proximity sensors, and may utilize any desired technology for the purpose of determining movement of the user's body (e.g., hand or arm). Other examples of the sensor 114 may include, but is not limited to, an infrared sensor, a blue tooth sensor, and a video sensor.

The power source 116 may provide power for some of the functionality of the hand-held device 102. The power source 116 may be a rechargeable power source such as, for example, a rechargeable battery. The power source may be directly connected to an AC input as is commonly available; however, the connection may inhibit movement.

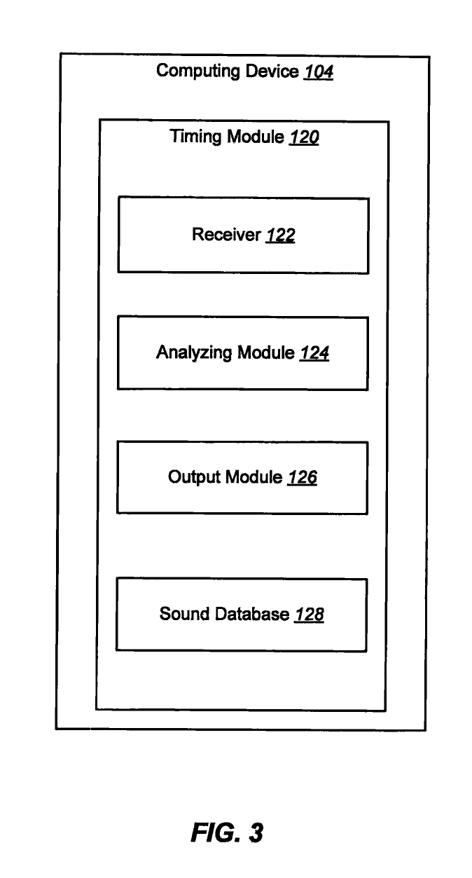

As shown by FIG. 1, the hand-held device 102 communicates with the computing device 104 of the system 100. Referring now to FIG. 3, the computing device 104 may include a timing module 120. The timing module 120 may be operable to provide real-time adjustment of beats and other parameters for the music as discussed above. The computing device 104 may include many other features, components and functionality besides those shown and described herein.

The timing module 120 may include a receiver 122, an analyzing module 124, an output module 126, and a sound database 128. The receiver 122 may provide electronic communication with the hand-held device 102 via, for example, the transmitter 110. The receiver 122 may receive the movement signals generated by the hand-held device 102. The analyzing module 124 may receive the movement signals and determine information from the movement signals. In one example, the analyzing module 124 determines from the movement signals a beat or tempo from movements of the user. For example, the analyzing module 124 may determine a down stroke of a conductor's hand that is holding the hand-held device 102. The down stroke may represent a beat or beginning of a measure of music.

The analyzing module 124 may include software and operate at least one algorithm. In one example, the analyzing module 124 operates at least one of the OSculator, MIDI beat clock, MIDI time code, MIDI conductor algorithm, digital performer sequencer, and logic pro described herein. In other arrangements, the analyzing module 124 may operate to create a modified beat or tempo that is adjusted in real time. The analyzing module 124 may communicate with the output module 126 to output the modified beat or tempo that is provided to a sound generating device. The analyzing module 124 may communicate with the output module 126 and sound database 128 to create modifications to an output such as, for example, a digital sound file.

The sound database 128 may include storage of a plurality of pre-recorded sounds. The sound database 128 may include at least one digital sound file such as, for example, a digital recording of orchestra music that includes a plurality of sounds representing a plurality of instruments of the orchestra. The sounds may be on a plurality of tracks. The sound database 128 may include other sounds such as, for example, a tapping sound, clicking sound, sound effects, or other sound that can convey the modified beat or tempo of the music.

In one embodiment, the sound database 128 may a pre-recorded sound file of a particular instrument or instruments. As explained above, the sound database 128 may also include a pre-recorded sequenced music file. In one configuration, the pre-recorded sound file of the particular instrument may be divided into click segments to approximate the click segments of the pre-recorded sequenced music file. As a result, a conductor may control (using the handheld device) the tempo of the pre-recorded sequenced music file together with the pre-recorded sound file of the particular instrument.

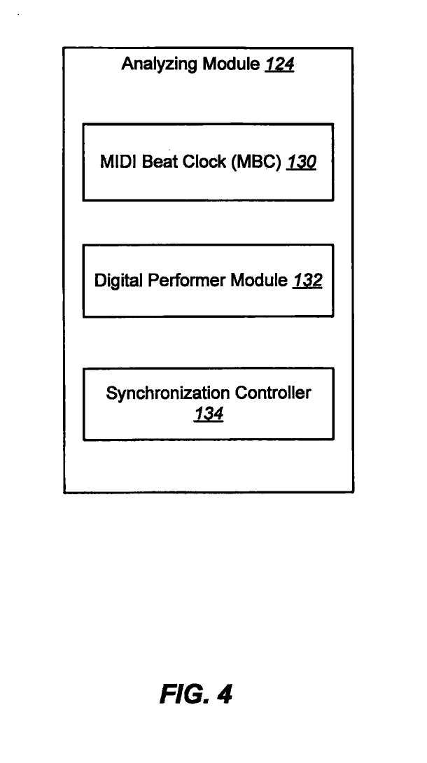

Referring to FIG. 4, the analyzing module 124 may include a plurality of components and functionality such as those described above. The analyzing module 124 may also include a MIDI beat clock (MBC) 130, a digital performer module 132, and a synchronization controller 134. Other example analyzing modules may include different components. Typically, the analyzing module 124 operates to execute the MIDI conductor algorithm to create customization of the music by the user operating the hand-held device 102.

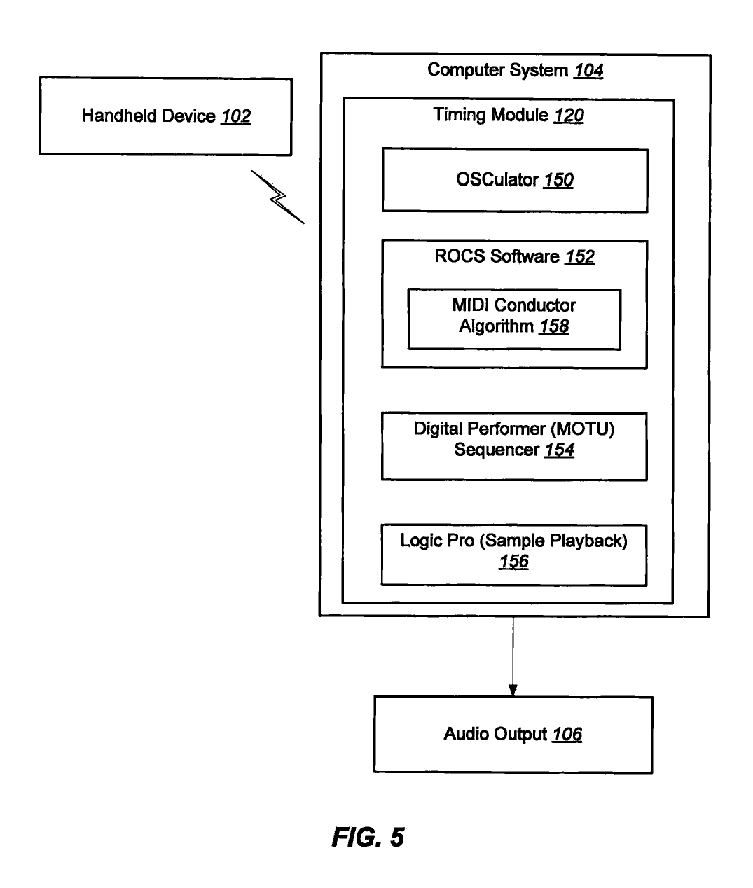

Referring to FIG. 5, the hand-held device 102 and computing device 104 are shown in communication with an audio output 106. The computing device 104 may include a timing module 120 having a different arrangement of features than that shown in FIG. 3. The timing module 120 may include an OSCulator 150, ROCS software 152 that operates a MIDI conductor algorithm 158, a digital performer (MOTU) sequencer 154, and a logic pro (sample playback) 156. In one configuration, the ROCS software 152 may compute an average click speed for future clicks from currently supplied clicks of the handheld device. If the sequence of currently supplied clicks is relatively slow, the average click speed may be expanded and more exact. If, however, the currently supplied clicks are more rapid in succession, the average click speed may be normalized and approximate a previously supplied click speed. A computing device 104 may communicate with an audio output 106 that generates an output of the music that has been modified in accordance with the music parameter that has been modified by the computing device 104.

The OSCulator may be operable to accept the movement signals from the hand-held device 102 via, for example, a BLUETOOTH communication, and then send out a software code (e.g., MIDI note, control command, key command) depending on the user's preference. OSCulator is available for download at www.osculator.net. The ROCS software 152 may receive the signals through the OSCulator 150 using a series of algorithm processes (e.g., the MIDI conductor algorithm 158). The ROCS software 152 controls, humanizes, and processes the information to create a humanized musical feel to each beat of the music. The output from the ROCS software 152 can provide the user (e.g., conductor) full control of tempo, phrasing, musical expression, etc., of a MIDI-sequence track.

The digital performer sequencer 154 may contain the MIDI sequence tracks that are sequenced according to the specifications determined by the ROCS software 152. The logic pro may contain a plurality of instrument music samples used to make a sound track, for example, an orchestra sound track. The logic pro 156 may be slaved to the digital performer sequencer 154. The digital performer sequencer 154 may be slaved to the ROCS software 152.

The systems and methods, as disclosed herein, may include additional features and functionality that are addressed by either the hand-held device 102 or computing device 104. The computing device 104 may be accessible via a user interface. The hand-held device 102 may also include a user interface such as a touch screen. The system may provide a humanized beat algorithm in accordance with those descriptions provided above. The system also may include, for example, a battery level indicator, a MIDI Time Code display that tracks the time code that is output from the computing device 104, a beat display that shows the current BPM as the user is conducting, and a continuous playing mode wherein actuating a button or switch provides continuous play of the music at the current BPM. The hand-held device 102 may include a button or switch (e.g., input device 112), which when activated provides an incremental increase or decrease in the BPM during, for example, a continuous play mode.

The system may include dial-in selection of a BPM. The continuous play mode may play at the dialed-in selected tempo. The system may further include a play enabling switch, a click enabling switch, and a song selection switch (e.g., a scroll up or scroll down) to a particular song or track to be played or conducted.

The system may also include capability to read a tempo (BPM) from a preset tempo track to run in continuous mode. The user can get into and out of the preset tempo mode at any time.

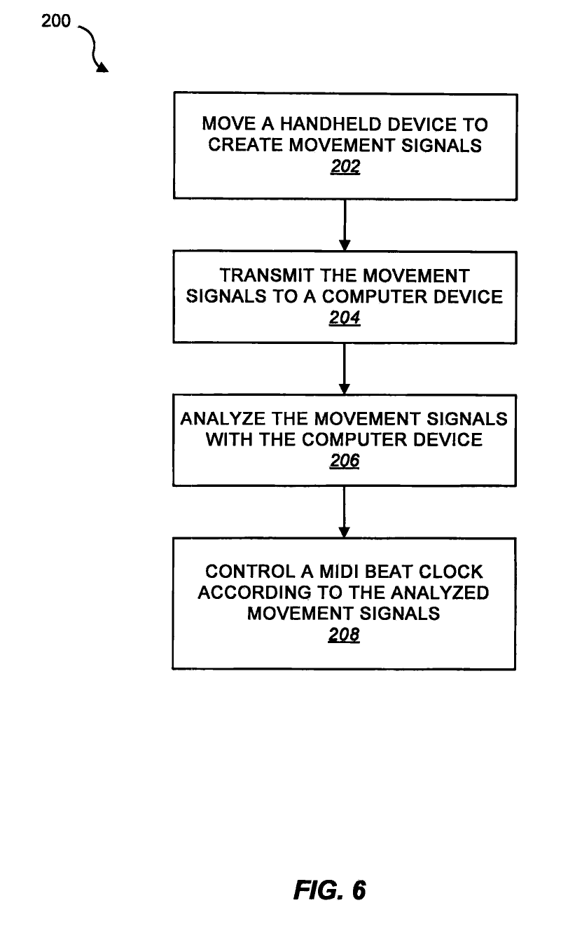

Referring now to FIG. 6, an example method possible in accordance with the system 100 of FIG. 1 is described. The method 200 may include a first operational step of moving a hand-held device to create movement signals 202. In a following step 204, the movement signals are transmitted to a computer device. In step 206, the movement signals are analyzed with the computing device. A MIDI beat clock is controlled according to the analyzed movement signals in a step 208.

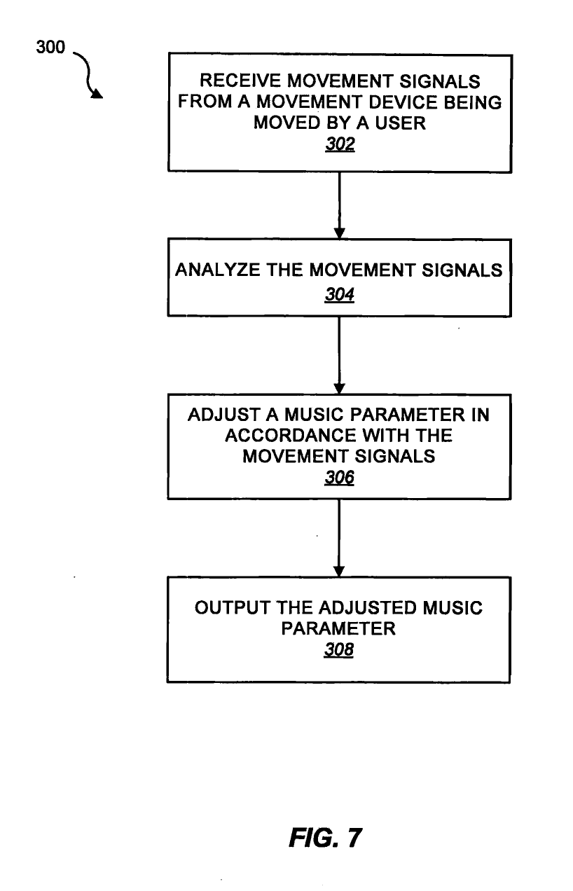

Referring to FIG. 7, the method 300 associated with operating the system 100 in FIG. 1 includes receiving movement signals from a movement device being moved by a user in a step 302. In a step 304, the movement signals are analyzed. In a step 306, a music parameter is adjusted in accordance with the movement signals. The adjusted music parameter is output in a step 308. The music parameters may include, for example, tempo markings (BPM), ritardandos (slowing down), accelerandos (speeding up), fermatas (holds), crescendos (getting louder), decrescendos (getting softer), and the overall balance of instruments in, for example, a sequenced orchestra. The music parameters may be adjusted in real time.

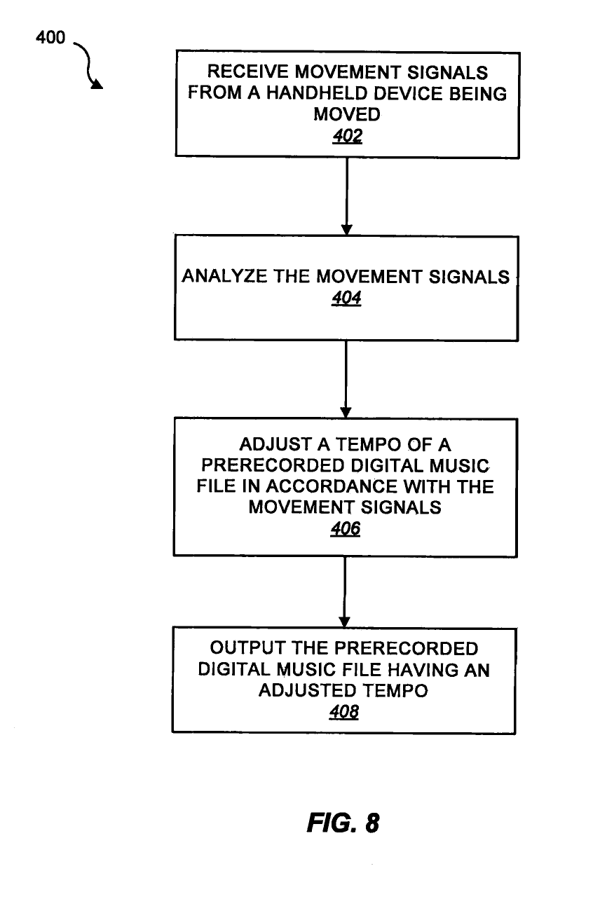

Referring to FIG. 8, another method 400 associated with the system 100 in FIG. 1 is shown. The method 400 may include receiving movement signals from a hand-held device being moved in a step 402. The movement signals are analyzed in a step 404. A tempo of a prerecorded digital music file is adjusted in accordance with the movement signals in a step 406. In a step 408, the prerecorded digital music file having an adjusted tempo is output to a sound generating device.

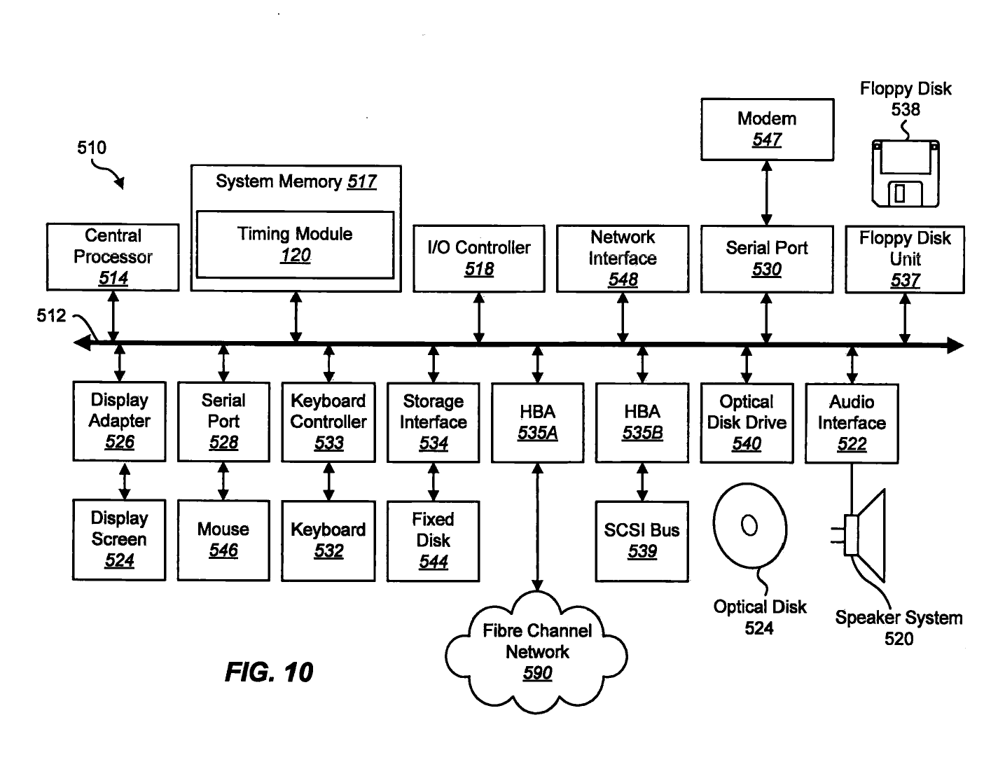

FIG. 10 depicts a block diagram of a computer system 510 suitable for implementing the present systems and methods. Computer system 510 includes a bus 512 which interconnects major subsystems of computer system 510, such as a central processor 514, a system memory 517 (typically RAM, but which may also include ROM, flash RAM, or the like), an input/output controller 518, an external audio device, such as a speaker system 520 via an audio output interface 522, an external device, such as a display screen 524 via display adapter 526, serial ports 528 and 530, a keyboard 532 (interfaced with a keyboard controller 533), a storage interface 534, a floppy disk drive 537 operative to receive a floppy disk 538, a host bus adapter (HBA) interface card 535A operative to connect with a Fibre Channel network 590, a host bus adapter (HBA) interface card 535B operative to connect to a SCSI bus 539, and an optical disk drive 540 operative to receive an optical disk 542. Also included are a mouse 546 (or other point-and-click device, coupled to bus 512 via serial port 528), a modem 547 (coupled to bus 512 via serial port 530), and a network interface 548 (coupled directly to bus 512).

Bus 512 allows data communication between central processor 514 and system memory 517, which may include read-only memory (ROM) or flash memory (neither shown), and random access memory (RAM) (not shown), as previously noted. The RAM is generally the main memory into which the operating system and application programs are loaded. The ROM or flash memory can contain, among other codes, the Basic Input-Output system (BIOS) which controls basic hardware operation such as the interaction with peripheral components or devices. For example, a timing module 120 may be used to implement the present systems and methods may be stored within the system memory 517. Applications resident with computer system 510 are generally stored on and accessed via a computer readable medium, such as a hard disk drive (e.g., fixed disk 544), an optical drive (e.g., optical drive 540), a floppy disk unit 537, or other storage medium. Additionally, applications can be in the form of electronic signals modulated in accordance with the application and data communication technology when accessed via network modem 547 or interface 548.

Storage interface 534, as with the other storage interfaces of computer system 510, can connect to a standard computer readable medium for storage and/or retrieval of information, such as a fixed disk drive 544. Fixed disk drive 544 may be a part of computer system 510 or may be separate and accessed through other interface systems. Modem 547 may provide a direct connection to a remote server via a telephone link or to the Internet via an internet service provider (ISP). Network interface 548 may provide a direct connection to a remote server via a direct network link to the Internet via a POP (point of presence). Network interface 548 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 10 need not be present to practice the present disclosure. The devices and subsystems can be interconnected in different ways from that shown in FIG. 10. The operation of a computer system such as that shown in FIG. 10 is readily known in the art and is not discussed in detail in this application. Code to implement the present disclosure can be stored in computer-readable storage media such as one or more of system memory 517, fixed disk drive 544, optical disk 542, or floppy disk 538. The operating system provided on computer system 510 may be MS-DOS®, MS-WINDOWS®, OS/2®, UNIX®, Linux®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present disclosure may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

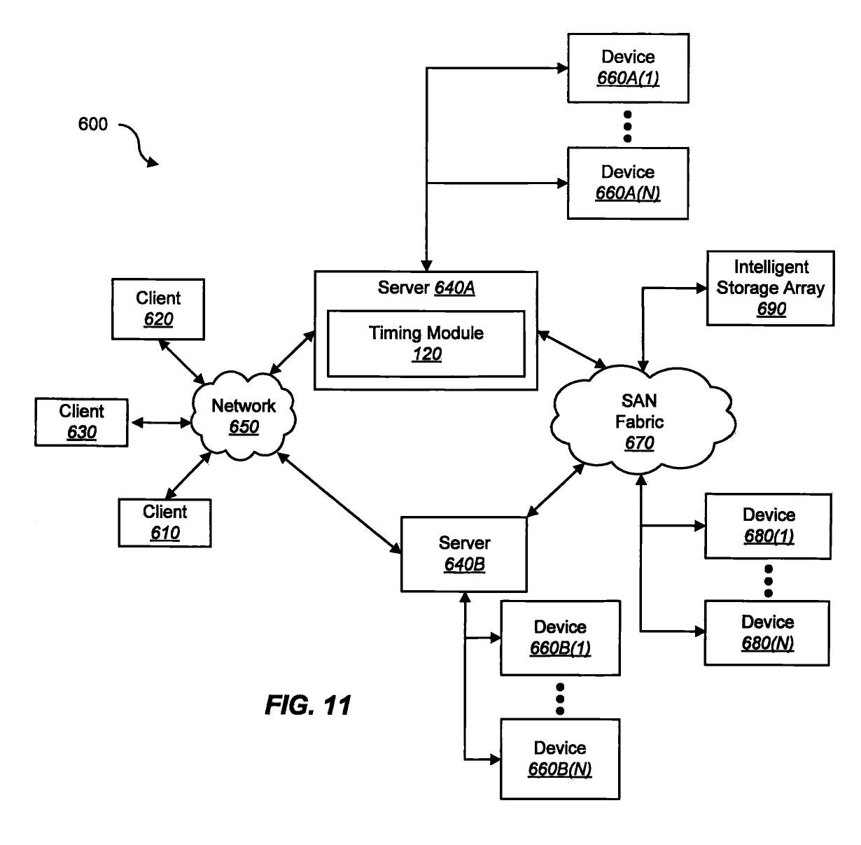

FIG. 11 is a block diagram depicting a network architecture 600 in which client systems 610, 620 and 630, as well as storage servers 640A and 640B (any of which can be implemented using computer system 610), are coupled to a network 650. In one embodiment, the timing module 120 may be located within a server 640A, 640B to implement the present systems and methods. The storage server 640A is further depicted as having storage devices 660A(1)-(N) directly attached, and storage server 640B is depicted with storage devices 660B(1)-(N) directly attached. SAN fabric 670 supports access to storage devices 680(1)-(N) by storage servers 640A and 640B, and so by client systems 610, 620 and 630 via network 650. Intelligent storage array 690 is also shown as an example of a specific storage device accessible via SAN fabric 670.

With reference to computer system 510, modem 547, network interface 548 or some other method can be used to provide connectivity from each of client computer systems 610, 620 and 630 to network 650. Client systems 610, 620 and 630 are able to access information on storage server 640A or 640B using, for example, a web browser or other client software (not shown). Such a client allows client systems 610, 620 and 630 to access data hosted by storage server 640A or 640B or one of storage devices 660A(1)-(N), 660B(1)-(N), 680(1)-(N) or intelligent storage array 690. FIG. 11 depicts the use of a network such as the Internet for exchanging data, but the present disclosure is not limited to the Internet or any particular network-based environment.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.”

What is claimed is:

1. A computer-implemented method for real time control of a MIDI beat clock, comprising:
moving a handheld device to create movement signals;
transmitting the movement signals to a computer device;
analyzing the movement signals with the computer device;
controlling a MIDI beat clock according to the analyzed movement signals.

2. The method of claim 1, wherein moving the handheld device includes holding the handheld device in a user's hand, and moving the handheld device according to a beat of a live performance.

3. The method of claim 1, wherein analyzing the movement signals includes determining from the movement signals which movements in the handheld device correspond to a beat.

4. The method of claim 1, wherein controlling the MIDI beat clock includes creating an adjusted beat output from the MIDI beat clock.

5. The method of claim 1, further comprising creating an audio output that generates sound in accordance with the MIDI beat clock.

6. The method of claim 1, wherein the handheld device includes at least one sensor and a transmitter, wherein moving the handheld device includes creating movement signals with the at least one sensor, and transmitting the movement signals with the transmitter.

7. The method of claim 1, wherein analyzing the movement signals includes operating an algorithm to predict a next beat based on intervals between previous beats.

8. A computer system configured to provide real-time adjustment to music parameters during generation of digital music output, comprising:
a processor;
memory in electronic communication with the processor;
a timing module configured to:
receive movement signals from a movement device being moved by a user;
analyze the movement signals;
adjust a music parameter in accordance with the movement signals;
output the adjusted music parameter.

9. The computer system of claim 8, wherein analyzing the movement signals includes determining an interval between predetermined types of movement signals.

10. The computer system of claim 8, wherein adjusting the music parameter includes adjusting at least one of a tempo marking, ritardandos, accelerandos, fermatas, crescendos, decrescendos, and instrument balance.

11. The computer system of claim 8, wherein the music parameter includes a music beat.

12. The computer system of claim 8, wherein adjusting the music parameter includes controlling a beat output from an MIDI beat clock.

13. The computer system of claim 8, wherein analyzing the movement signals includes determining at least one of a change of speed and a change of direction for an object being moved to create the movement signals.

14. The computer system of claim 8, further comprising generating an audio output based on the output adjusted music parameter.

15. The computer system of claim 8, wherein the timing module includes an analyzing module comprising at least one of a MIDI beat clock, a digital performer module and a synchronization module, and operable to adjust a music parameter in accordance with the movement signals.

16. A computer-program product for adjusting a tempo of a prerecorded digital music file, the computer-program product comprising a computer-readable medium having instructions thereon, the instructions comprising:
code programmed to receive movement signals from a handheld device being moved;
code programmed to analyze the movement signals;
code programmed to adjust a tempo of the prerecorded digital music file in accordance with the movement signals;
code programmed to output the prerecorded digital music file having an adjusted tempo.

17. The computer-program product of claim 16, wherein the code programmed to analyze the movement signals determines a music beat from the movement signals.

18. The computer-program product of claim 16, wherein the code programmed to adjust a tempo of the prerecorded digital music file in accordance with the movement signals predicts a next beat of a live musical performance represented by the movement signals.

19. The computer-program product of claim 16, further comprising the code programmed to control a MIDI beat clock according to the analyzed movement signals.

20. The computer-program product of claim 16, wherein the code programmed to output the prerecorded digital music file having an adjusted tempo is configured to output a click track.
